(19) United States
(12) Patent Application Publication
(10) Pub. No.: US 2015/0186863 A1
(43) Pub. Date: Jul. 2, 2015

(54) ACCOUNT PURCHASE LIMITS FOR DEPENDENT USER

(71) Applicant: Bank of America Corporation, Charlotte, NC (US)

(72) Inventors: Andrew P. Schwalb, Mount Dora, FL (US); Randoll Scott Beavers, New London, PA (US); Marshall J. Bonacquisti, Newark, DE (US); Tal Sadan, New Egypt, NJ (US); Suneetha R. Sadda, Cranbury, NJ (US)

(73) Assignee: Bank of America Corporation, Charlotte, NC (US)

(21) Appl. No.: 14/146,305

(22) Filed: Jan. 2, 2014

(51) Int. Cl. G06Q 20/24; G06Q 20/40

(52) U.S. Cl. CPC G06Q 20/24; G06Q 20/405

(57) ABSTRACT

Embodiments of the prevent invention allow a primary user to create a dependent account in order to control and monitor the transactions made by a dependent user. The primary user can limit the transactions that the dependent user can make at a store or for products. The primary user can set transaction amount limits and transaction time limits on the transactions the dependent user can make. The primary user may also set allocation limits that limit the amount of an allowed transaction that can be applied to the dependent account. The difference between the allowed transaction amount and the allocation limit amount is paid for through the use of another account. The alternate account may be pre-determined, may be determined at the time of the transaction, or at a later point in time after the transaction has been completed between the dependent user and the merchant.

### FIELD

This invention relates generally to the field of dependent accounts, and more particularly embodiments of the invention relate to apparatuses and methods for a dependent account, such as a credit card or other type of account, which provides the primary user flexible control mechanisms over the use of the dependent account by the dependent user.

### BACKGROUND

It may be difficult for some people with limited financial transaction history to be approved for a credit card, or other type of financial account. Furthermore, customers are typically averse to acting as co-signers for people with limited financial transaction history because they do not want to be liable for any debt that other people on the account might accrue. As such, some customers in some situations may want to control the purchases of other customers, for example with parent-child, child-parent, employer-employee, legal representative-legal dependent, or other like relationships.

### BRIEF SUMMARY

Embodiments of the present invention address the above needs and/or achieve other advantages by providing apparatuses (e.g., a system, computer program product, and/or other device) and methods that help a primary user of one or more accounts control the transactions made by a dependent user of the one or more accounts.

Embodiments of the prevent invention allow a primary user to open a dependent account (or link a current account to a dependent user), such as, but not limited to, a dependent credit card account in order to control and monitor the transactions made by a dependent user that is authorized to use the dependent account controlled by the primary user. In other embodiments of the invention, other types of accounts may be used, such as debit accounts. Examples of a dependent account are generally described herein with reference to a dependent credit card account; however, references to credit cards, dependent credit card accounts, or other types of financial accounts, may be replaced by references to other types of accounts, such as debit accounts or the like, throughout this application and the invention discussed herein applies to the other types of accounts.

In some embodiments of the invention the primary user discussed herein may be a parent and the dependent user discussed herein may be a child. In other embodiments the primary user may be an owner, manager, or employee within a business that would like to control the spending of a dependent user who may be another employee of the business. In other embodiments of the invention the primary user may be a guardian and dependent user is a legal dependent of the primary user. In still other embodiments of the invention the primary user may be a child and the dependent user may be parent of the child that may need help in managing finances. In some embodiments the primary user may be a trustee and the dependent user may be beneficiary of the trust. In other embodiments the primary user may be any person, while the dependent user is any other person agreeing to allow the primary user to control the use of the dependent user's account or use of the primary user's account. Furthermore, although a credit card is often used herein to describe the payment device that is utilized to make a transaction, it should be understood that the present invention may include payment devices other than cards and/or financial accounts other than credit card accounts. For example, instead of a credit card the payment device may be a debit card, gift card, reward card, or another other type of card. In other embodiments the payment device may be a mobile wallet, phone application, near-field communication device, or any other type of electronic payment device, or may simply be account information that is stored within a database and electronically transferred to enter into a transaction. The financial accounts may be any type of account, such as, but not limited to checking accounts, debit accounts, savings accounts, investment accounts, prepaid accounts, or any other type of account.

In some embodiments, the primary user can set a maximum limit that the dependent user can spend using an account up to the maximum amount (e.g., up to or equal to) that the financial institution has approved for the account. In some embodiments, the primary user can also limit the transactions that the dependent user can make at a store (e.g., a physical store location, over the Internet, over the telephone with a representative, or the like) or on goods or services (hereinafter “products”). In some embodiments limits on the stores include specific stores, such as, but not limited to chain stores or individual stores, or in other embodiments the limits on stores includes stores that are grouped together in various categories. A store can be grouped in more than one category, for example a one-stop shopping store that sells a range of products can be grouped as both a grocery store and an electronics store. With respect to the limits on products, in some embodiments, the limits include a single product, or in other embodiments product limits include limits on the type of products that are grouped together in various categories, or limits on a brand that covers a range of products. A product can be grouped into more than one category of products, for example, a specific beverage can be grouped into a category with other beverages, and also be grouped into a snack food category that includes beverages, chips, cookies, candy, and the like.

The primary user can limit the transactions that the dependent user can make by, for example, adding Merchant Category Codes (MCCs), store names, store types, Universal Product Codes (UPCs), Stock Keeping Unit Codes (SKUs), product names, product types, and/or other like identifiers (e.g., merchant identifiers or product identifiers) to a blocked list or an approved list of stores or products. In other embodiments, the primary user can set transaction amount limits and transaction time limits on the transactions the dependent user can make at the blocked/approved stores or on the blocked/approved products that the primary user added to the blocked/approved list. In some embodiments of the invention the transaction time limits are days, weeks, months, or the like, but in other embodiments the time limits may be times of day (e.g., morning, afternoon, night), or specific hours of the day (e.g., between 11 am and 1 pm).

In other embodiments of the invention other limits, such as transaction type limits (e.g., in store purchase vs. online purchase, or the like), location limits (e.g., radius location, zip code, state, region, or the like), or variance limits (e.g., particular transactions may be a percentage or dollar amount over the limits). In addition to the merchant limits and product limits, these types of limits may be described herein as transaction account limits, while the limits on the amounts of the transaction may be described herein a transaction amount limits, and the limits on the time of the transaction may be described as transaction time limits.

Furthermore, the primary user can periodically edit the transaction account limits (e.g., merchant limits or the products limits) on the blocked/approved list, as well as the transaction amount limits, the transaction time limits, and other limits in order to control the transactions made by the dependent user as the needs of the dependent user change. In some embodiments, both the primary user and dependent user can view the transactions made through the account by logging into an online banking account. The dependent user may be prevented from having the ability to access the sections of the dependent account related to the limits set by the primary user, which control the transactions the dependent user is allowed to make.

A blocked list of transactions allows a dependent user to enter into the transactions on the list according to the limits on the list as well as all other types of transactions not specifically included in the list. An approved list of transactions allows the primary user to limit the transactions that the dependent user can enter into to only the transactions on the list according to the limits and no other transactions outside of what is listed. The blocked list and approved list work in much the same way, in that the primary user can set transaction account limits on the stores and products by using merchant or product identifiers, or other types of limits, as well as transaction amount limits and transaction time limits. As such, the dependent user can make any type of transaction outside of any store or product on the blocked list, while the approved list only allows the dependent user to make transactions that are included on the approved list.

In addition to the limits discussed above the primary user may also set allocation limits that limit the amount of an allowed transaction that can be applied to the dependent account. The difference between the allowed transaction amount and the allocation limit amount is to be paid for through the use of another account of the primary user or dependent user. The alternate account may be pre-determined, may be determined at the time of the transaction, or at a later point in time after the transaction has been completed between the dependent user and the merchant.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a high level process flow for a dependent account process, in accordance with one embodiment of the present invention;

FIG. 2A illustrates a dependent account limit process, in accordance with one embodiment of the present invention;

FIG. 2B illustrates a dependent account allocation process, in accordance with one embodiment of the present invention;

FIG. 3 provides an online banking interface for setting up a dependent account, in accordance with one embodiment of the present invention;

FIG. 4 provides an online banking dependent account interface, in accordance with one embodiment of the present invention;

FIG. 5 provides an online banking dependent merchant limit interface, in accordance with one embodiment of the present invention;

FIG. 6 provides an online banking dependent product limit interface, in accordance with one embodiment of the present invention;

FIG. 7 provides an online banking dependent account limit interface, in accordance with one embodiment of the present invention;

FIG. 8 provides an online banking transaction history interface, in accordance with one embodiment of the present invention; and

FIG. 9 provides a block diagram illustrating a dependent account environment and system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution” or “bank,” one of ordinary skill in the art will appreciate that other embodiments of the invention may involve other businesses that take the place of or work in conjunction with the financial institution or bank to perform one or more of the processes or steps described herein as being performed by a financial institution. Still in other embodiments of the invention the financial institution or bank described herein may be replaced with other types of businesses that offer account services to customers.

As further described herein users 9 may be either primary users or dependent users. As previously described, the primary users are generally users 9 that control the dependent accounts, set the limits on the dependent accounts, and in some embodiments are ultimately responsible for the debt accrued through the use of the dependent accounts. The primary users, in some cases, are the only users 9 that can set-up and change the transaction account limits, transaction amount limits, transaction time limits, and allocation limits, as is described in further detail later, which are used for controlling the transactions of the dependent users, and allocation of the transaction costs.

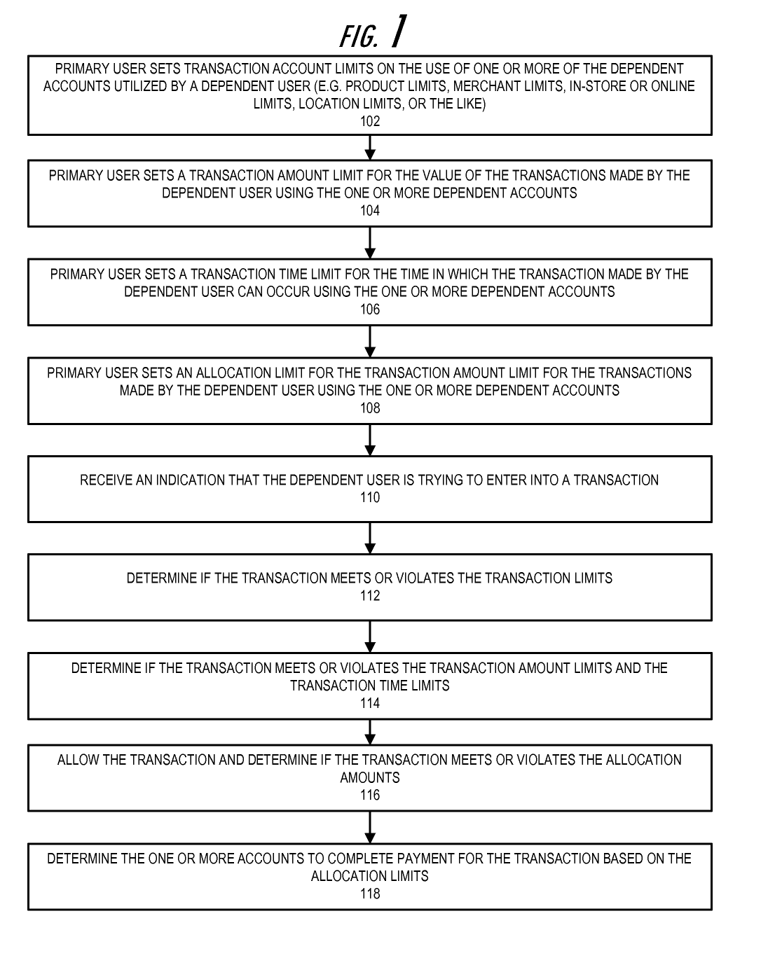

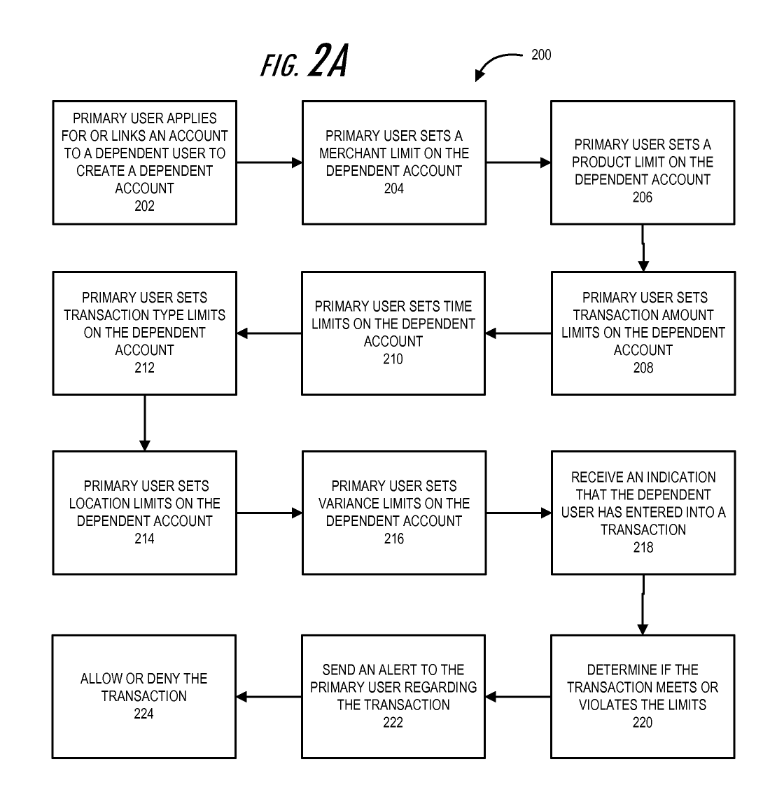

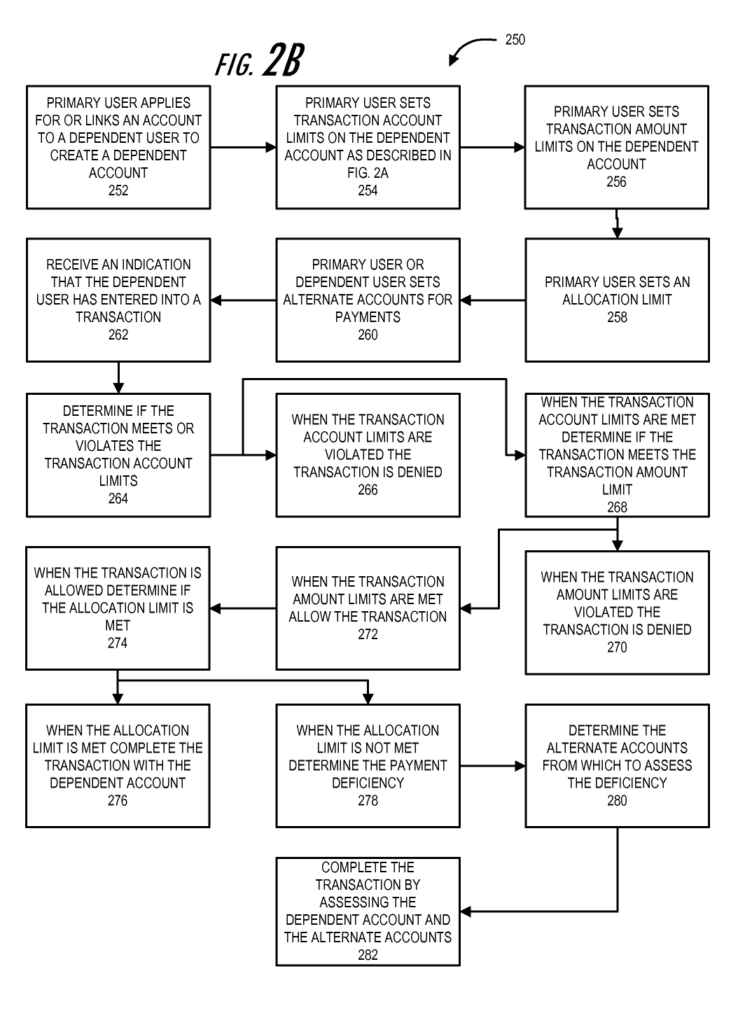

FIG. 1 illustrates a high level process flow for a dependent account process 100, in accordance with one embodiment of the invention. As illustrated by block 102 of FIG. 1 a primary user may set account limits on the potential transactions made using one or more of the dependent accounts by the dependent user. Some of the limits may include product limits (e.g., product names, brand names, SKU code limits, UPC code limits, product categories, or the like), merchant limits (e.g., merchant names, MCCs, merchant categories, or the like), transaction type limits (e.g., in-store purchases, online purchases, in-store online purchases, or the like), location limits (e.g., zip codes, location determining device radius limits, area limits like street, city, county, state, region, country, or the like), or other like limits. These limits are described in further detail with respect to FIG. 2A.

As illustrated by block 104 of FIG. 1, a primary user sets a transaction amount limit for the value of one or more of the transaction account limits from block 102. In some embodiments of the invention, the transaction amount limit may include a maximum amount for a product or a group of products for which the dependent user may utilize the one or more dependent accounts. For example, as explained in further detail below with respect to FIG. 2A, this may limit the purchases made by a dependent user to a particular dollar amount at a particular store for a particular type of product, such as $200 for a TV at an all in one store (e.g., store that sells groceries, clothes, electronics, or the like), and the product may be limited to only TVs.

Block 106 of FIG. 1 illustrates that a primary user may set a transaction time limit for the one or more transaction account limits from block 102. The time limits may limit the transactions to a specific hour, time of day, week, month, or the like. For example, as explained in further detail below the transaction account limit for a TV may be limited to the current month (or other time period) and a transaction made outside of the current month (or other time period) would not be approved.

As illustrated by block 108, the primary user may also set an allocation limit for the transaction amount limit in block 104. The allocation limit may limit the amount of a transaction that can be applied to a particular dependent account. For example, continuing with the example provided for block 104, while there may be a $200 transaction amount limit, the primary user may only want to allow a portion of the $200 transaction amount limit using a first dependent account. As such the allocation limit may only be $150. The purchase for the TV may only be made when a particular TV is purchased from a particular store based on the transaction account limits from block 102, and the TV costs less than $200 based on the transaction amount limit from block 104; however, only $150 is charged to the first dependent account, and either the remainder is charged to another account or paid by the dependent user himself at the point of sale (e.g., cash). In other embodiments of the invention the allocation limit may be used a number of different ways to control the purchases a dependent user, as will be explained in further detail with respect to FIG. 2B.

After the limits are set, as illustrated by block 110, an indication is received by the financial institution that a dependent user has entered into a transaction. The financial institution determines if the transaction meets or violates the transaction account limits set in block 102, as illustrated in block 112. If the account limits are violated then the transaction may be denied. If however, the account limits are met, then as illustrated by block 114 the financial institution determines if the transaction meets or violates the transaction amount limits and the transaction time limits. If the transaction amount limits or transaction time limits are violated then the transaction may be denied. If however, the transaction amount limits and transaction time limits are met, then as illustrated by block 116 the transaction is allowed and a determination is made if the transaction meets or violates the allocation limits. If the transaction meets the allocation limits then the transaction is allowed. However, as illustrated by block 118 if the transaction violates the allocation limits then a determination is made on where to allocate the deficiency in the transaction amount to other accounts (e.g., other dependent user accounts, another account owned by the dependent user that is not controlled by the primary user, credit card, cash, debit account, or the like that the dependent user controls or that belongs to the primary user, or the like). As such, the present invention allows a primary user to not only control the purchases of a dependent user by controlling limits on the transaction, but may also allocate how the transaction may be funded.

FIG. 2A illustrates a dependent account limit process 200, in accordance with one embodiment of the invention. As illustrated by block 202 in FIG. 2A, the primary user applies for a dependent account, or links a current primary account to a dependent user to create a dependent account. In some embodiments of the invention, this may comprise the primary user applying for a dependent account on behalf of or along with the dependent user. In some embodiments of the invention the primary user can fill out application and electronically file or mail the application into the financial institution or company offering the dependent account. In other embodiments, the primary user can apply over the telephone, instant message, e-mail, or the like for a dependent account. In an example embodiment disclosed herein, the primary user may apply for a dependent credit card through the primary user's online banking account using an online banking application 17 and web browsing application 37. It is understood that embodiments of the present invention may work equally well in applying for a dependent credit card, or other dependent account, through various channels. In order to apply for a dependent credit card through the primary user's online banking account the primary user first may log into the primary user's online banking account, and the online banking application 17 authenticates the primary user as the correct customer for the corresponding online banking account.

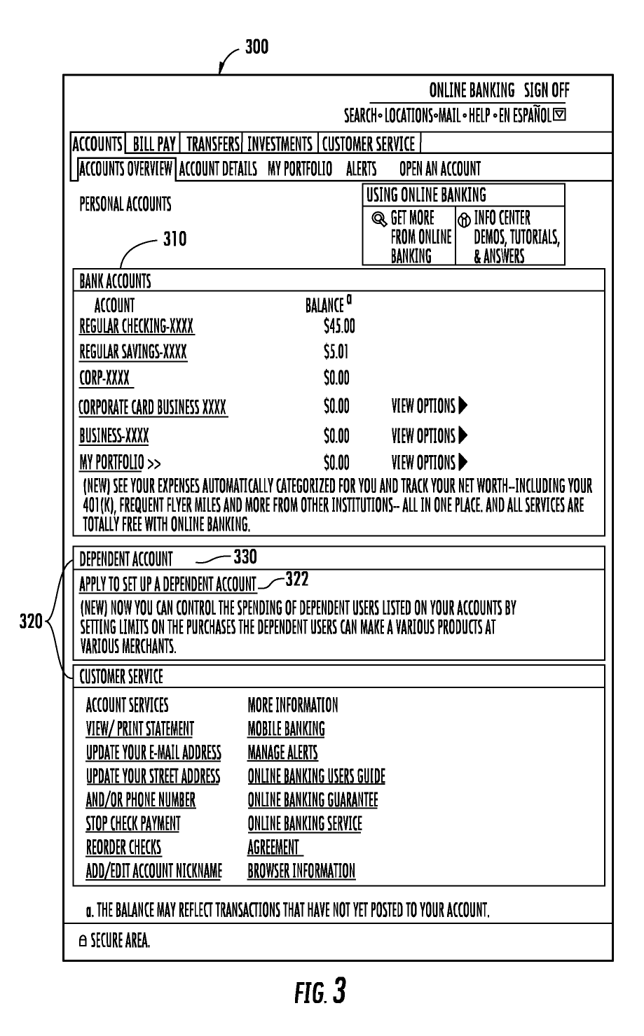

After the primary user is authenticated, the online banking application 17 displays the online banking home page interface 300, as illustrated in FIG. 3. In some embodiments, as illustrated in FIG. 3, the online banking home page interface 300 has a Bank Accounts section 310, a Customer Service Section 320, and a Dependent Accounts section 330. The primary user can navigate the Bank Accounts section 310 to review and analyze the accounts that the primary user has with the bank. In some embodiments of the invention, if the primary user has already been approved for a dependent account, the Bank Accounts section 310 may have a link for the dependent account. The Customer Service section 320 allows the primary user to find, receive, and ask for help related to various topics within the bank. As illustrated by the Dependent Account section 330, the primary user may select a dependent account link 332 in order to apply for the dependent account.

In other embodiments of the invention, the primary user may take a current account that is owned by the primary user and link the account to a dependent user (e.g., add the dependent user to the primary account to create a dependent account), and as such the dependent user may be able to enter into transactions using the dependent account. For example, a primary user may have a credit card account that the primary user links to a dependent user. As such, the dependent user may receive a credit card that is linked to the primary user's credit card account. In other embodiments the link may be an electronic link that allows the dependent user to make transactions using a mobile wallet or other like device using the primary user's account.

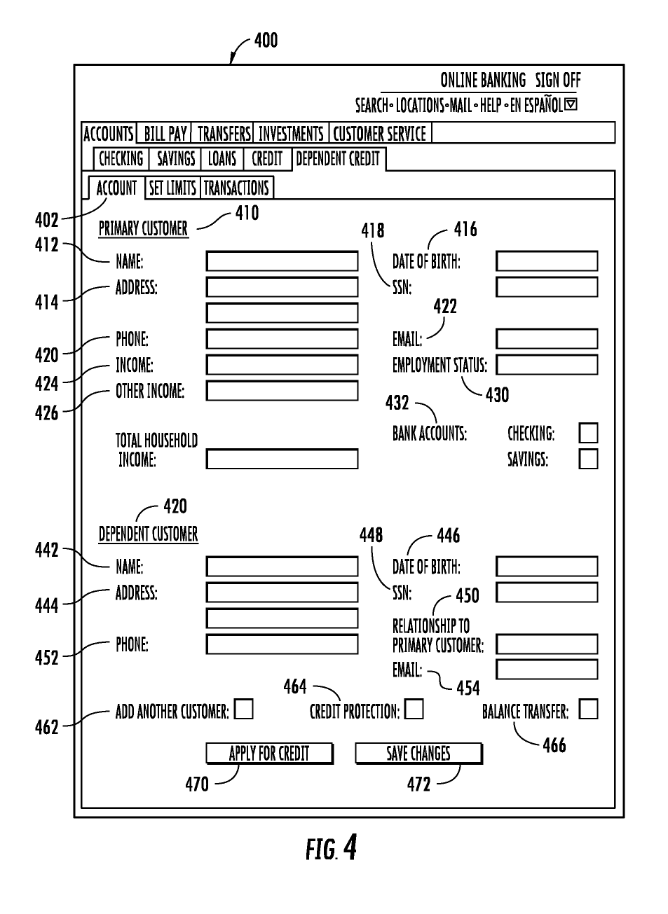

Continuing with the example of applying for a dependent credit card, after selecting the dependent credit card link 332 the primary user is taken to the account interface 400 in the account tab 402, as illustrated by FIG. 4. As previously discussed, applying for a dependent credit card, or other dependent account, through the online banking system is one of many ways that a primary or dependent user can apply for a dependent credit card. As illustrated in the account interface 400 there is a primary user section 410 and a dependent user section 440. In the primary user section 410 the primary user enters personal information, such as, but not limited to, the primary user's name 412, address 414, date of birth 416, social security number (SSN) 418, phone 420, e-mail 422, income 424, other income 426, total household income 428, employment status 430, and bank accounts 432 held with the financial institution. In other embodiments of the invention the primary user may be prompted to provide additional information, such as, but not limited to, copies of pay stubs, accounts and corresponding balances located at other financial institutions, outstanding debt, or the like in order for the financial institution to open an account for the primary user. In other embodiments of the invention, the primary user also fills in the dependent user section 440 of the application with the dependent user information. In some embodiments of the invention, the primary user provides information such as, but not limited to, the dependent user's name 442, address 444, date of birth 446, SSN 448, relationship to the primary user 450, phone 452, and e-mail 454. In some embodiments the primary user also can add another dependent user to the dependent credit card by selecting the add another customer button 462, which allows the primary user to add more than one dependent user to the dependent credit card account. In other embodiments of the invention the primary user can also apply for credit protection or a balance transfer for the account using the credit protection button 464 or the balance transfer button 466. When the primary user has completed the application the primary user selects the Apply for Credit button 470. In other embodiments of the invention, the account information in the account interface 400 used to apply for the dependent credit card can be updated and saved using the Save Changes button 472 whenever the information for the primary user and/or the dependent user changes.

In some embodiments the dependent user may log into his online banking account to participate in the application process, such as to complete the dependent user section 440. In some embodiments of the invention the dependent user may fill out the dependent user section 440 first and ask a person to act as the primary user by having the person sign into the primary user's online banking account to fill out the rest of the application. In other embodiments of the invention, the dependent user logs into the online banking account after the primary user has filled out the primary user section 410 of the application. In some embodiments of the invention the primary user and dependent user may sign into the online banking account before the dependent credit card is issued in order to agree to the terms and conditions of the card. In other embodiments of the invention the primary user or dependent user can fill out or apply for a part of or all of the dependent credit card application through another channel, such as, in person at the bank, over e-mail, over instant message, or the like.

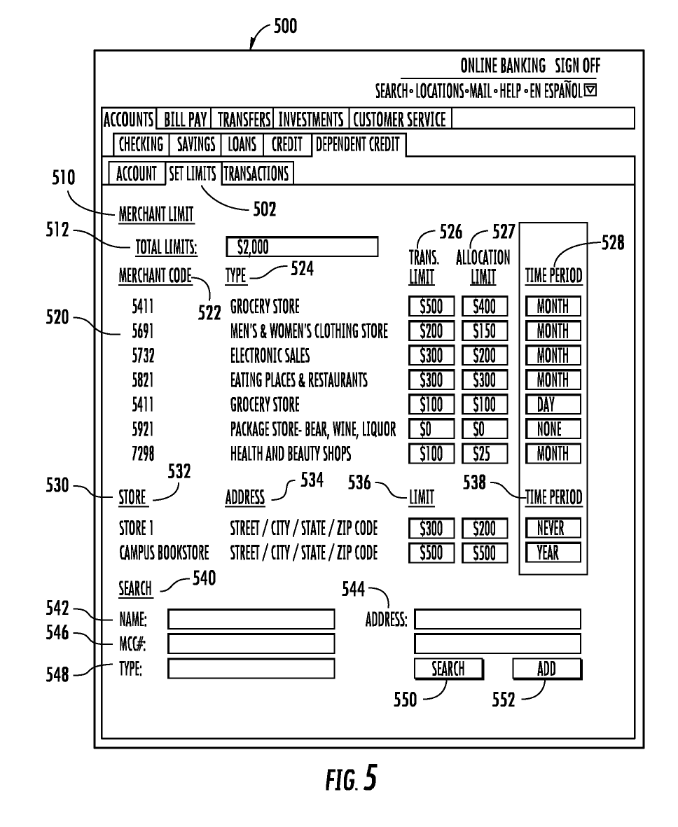

After the primary user has created the dependent account, the primary user can begin to set the account limits on the dependent account. In some embodiments the primary user can set a dependent account balance limit, block/approve specific MCCs, stores, and/or products using the primary user's online banking account. FIG. 5 illustrates a dependent merchant limit interface 500 in the set limit tab 502. The dependent merchant limit interface 500 has an account limit section 510 that includes a total dependent account balance limit 512, a merchant code limit section 520, a store limit section 530, and a search section 540. The primary user can set the total account balance limit for the dependent account (e.g., credit card account) if the primary user thinks that the maximum account limit determined by the financial institution is too high for the dependent user. For example, the financial institution may determine that the account limit for the dependent user based on a payment performance indicator of the primary user and dependent user should be a maximum of five thousand (5,000) dollars. The primary user may feel that this account limit is too high for the dependent user. Therefore, the primary user has the option to set the account limit at a lower amount, for example two thousand (2,000) dollars, by entering the amount in the total dependent account balance limit section 512 of the dependent merchant limit interface 500.

As illustrated by block 204 of FIG. 2A, the primary user may set a merchant limit on the dependent account such as a limit on a specific store (e.g., specific merchant) or a store category (e.g., type of merchant). The primary user can create a blocked/approved list of transactions at a merchant by, for example, selecting particular MCCs or other types of merchant codes, store names, store types, store categories, or the like (collectively “merchant identifiers”) to include on a blocked/approved list of transactions. For example, in one embodiment the primary user controls the types of purchases by adding MCCs to a list of blocked/approved MCCs in the MCC limit section 520. MCCs are industry standard codes assigned to types of stores, individual stores, or potentially in some cases actual products, in an effort to categorize the types of stores, specific stores, and/or products into various groups. As illustrated in FIG. 5, in some embodiments the MCC limit section 520 may list the merchant code 522, the type 524 of store, actual store, or product, the merchant transaction amount limit 526 for the related merchant code 522, a merchant allocation limit 527 (explained in further detail later), and the merchant time limit 528 for the related merchant code. Therefore, the primary user can add different merchant codes (e.g., MCCs), such as, but not limited to merchant codes for grocery stores, men's and women's clothing stores, electronic stores, eating places and restaurants, package stores (for beer, wine, and liquor), health and beauty shops, or the like to a blocked/approved list of transactions that the primary user wants to regulate for the dependent user.

As illustrated in FIG. 5 and in block 208 of FIG. 2A, the primary user can place a particular merchant transaction amount limit 526 on the amount of money the dependent user can spend in a type of store or in a specific store. In some embodiments, the primary user can also place a merchant time limit 528 on the merchant transaction amount limit 526 for the particular merchant codes, stores, or types of stores, as explained in further detail below with respect to block 210 of FIG. 2A. For example, as illustrated in FIG. 5, the primary user can add the MCC for grocery stores to the blocked/approved list and set a monetary limit of five hundred (500) dollars to the grocery store, therefore preventing the dependent user from spending more than five hundred (500) dollars at a grocery store.

In some embodiments of the invention the primary user can put different limits on the same merchants. For example, as illustrated in FIG. 5, the primary user can also set a limit of one hundred (100) dollars a day at a grocery store, therefore preventing the dependent user from spending both more than one hundred (100) dollars a day and five hundred (500) dollars a month at a grocery store.

If the primary user does not want the dependent user to be able to purchase anything related to a particular merchant, in one embodiment the primary user can set a limit of zero (0) dollars for the particular merchant. For example, if the primary user wants to prevent a dependent user from purchasing any products at a package store, such as beer, wine, and liquor, the primary user sets a limit of zero (0) dollars on the merchant related to package stores. In other embodiments of the invention no transaction amount limits are included on the blocked list, and as such if a merchant is added to the blocked list the dependent user is simply not allowed to purchase anything from the merchant. This may also apply to an approved list in which the merchants on the approved list are the only merchants with which the dependent user may enter into transactions.

In other embodiments of the invention, the primary user can add specific stores to the blocked list if the primary user wants to limit the transactions the dependent user can make at specific stores. For example, as illustrated in FIG. 5, the primary user can prevent the dependent user from spending more than two hundred (200) dollars at Store 1.

In order to add the merchant codes, or other particular stores to the blocked/approved list, in one embodiment, the primary user can enter the MCC, type of store, store name, address, or the like directly into the blocked/approved list. In other embodiments, the primary user can enter the MCC, type of store, store name, address, or the like into a search feature and thereafter into the blocked/approved list after each is found through the search feature. As illustrated in the search section 540 of FIG. 5, the primary user can enter the name of a store into the name section 542, the address of the store into the address section 544, the MCC into the MCC section 546, or the type of store into the type section 548, and thereafter select the search button 550 to identify the store or MCC based on the search criteria. When the correct store or MCC is identified the primary user can select the add button 552 to add the store or MCC to the blocked/approved list. Thereafter, the primary user can set the merchant transaction amount limits 526 and merchant time limits 528 for each MCC or store as previously described. In other embodiments of the invention, the blocked/approved lists or the search section 540 includes drop-down features or browsing lists that contain the store name, store types, store identifiers, product names, products types, and/or product identifiers that allow a primary user to identify the stores or products that the primary user wants to add to the blocked/approved lists.

In some embodiments of the invention the primary user can add a range of MCCs (or other merchant identifiers) to the blocked/approved list, so that the dependent user does not need to add every individual MCC related to a particular industry to the blocked/approved list. For example, the primary user can add the group of MCCs from three-thousand (3000) to three-thousand two-hundred and ninety-nine (3299) which covers “Airlines” in order to limit the transactions the dependent user can make with merchants related to airlines.

As illustrated by block 206, a primary user may also set a product limit on the dependent account. The primary user can create a blocked/approved list of transactions for products by, for example, selecting particular UPCs, SKUs, or other types of product codes, product names, product types, product brands, product categories, or the like (collectively “product identifiers”). For example, UPCs are codes that are assigned to each product in the market. The UPCs have a bar code assigned to each UPC such that when the product is purchased computer systems identify the product for purposes such as pricing, accounting, inventory, or the like. UPCs or other product codes may be used to add products to the blocked/approved list.

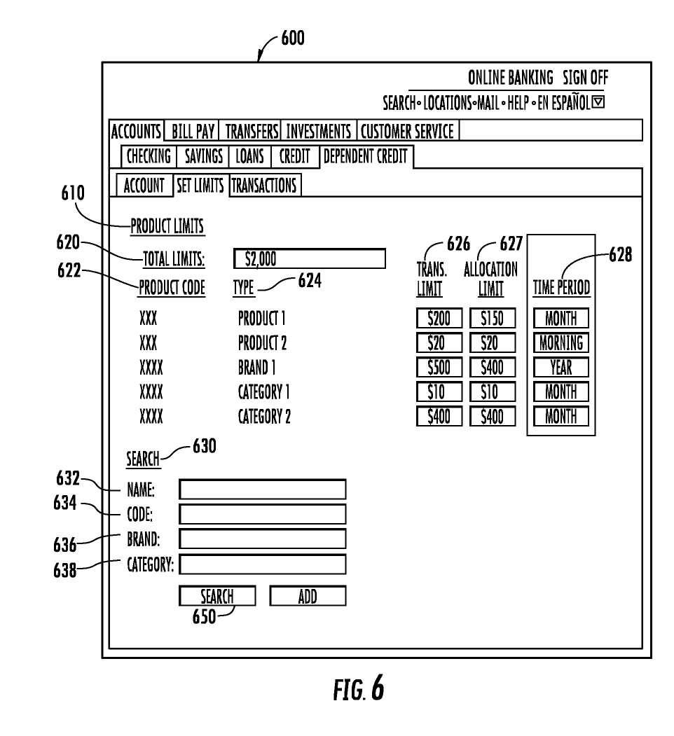

The product identifiers may be used to add products to the blocked/approved list in the same way as was discussed with respect to the merchant identifiers in block 204 of FIG. 2A. For example, products can be added to the blocked/approved list using a product identifier as illustrated in the dependent product limit interface 600 in FIG. 6. FIG. 6 illustrates a product limit section 610 that illustrates the total account limits as was previously discussed with respect to the merchant limit section 510. The dependent product limit interface 600 further illustrates a product limit section 620 for adding products to a blocked/approved list of products, for example, by using UPCs or other product identifiers to a blocked/approved list of products. As illustrated in FIG. 6, the product limit section 620 lists the product code 622, the product type 624 (e.g., product type, actual product, product group, product brand, or the like), the product transaction amount limit 626 on the related product, a product allocation limit 627 (explained in further detail later) and a product time limit 628 for the extent of the limit. Therefore, the primary user can add different products, such as, but not limited individual products (e.g., Product 1 and Product 2), a group of products (e.g., Brand 1), or a type of product (e.g., Category 1 and Category 2) to a blocked list of purchases that the primary user wants to regulate or limit the dependent user from making. In some embodiments of the invention, adding a product to a blocked list completely prevents the dependent user from making purchases at any store for the product. In other embodiments of the invention adding the products to an approved/blocked list only limits a dependent user from making purchases of product based on the limits provided in the list.

As illustrated in FIG. 6 and in block 208 of FIG. 2A, the primary user can place a particular monetary limit on the amount of money the dependent user can spend on a product. The primary user can also place time limits on the product limits for particular products, type of products, or groups of products, as explained in further detail below with respect to block 210 of FIG. 2A. For example, as illustrated in FIG. 6, the primary user can add a product code (e.g., Product 1) to the blocked/approved list and set a monetary limit of two hundred (200) dollars to Product 1 per month. Therefore, the dependent user is prevented from spending more than two hundred (200) dollars for Product 1 each month.

If the primary user does not want the dependent user to be able to purchase anything related to a particular product, in one embodiment the primary user can set a limit of zero (0) dollars for the particular product. For example, if the primary user wants to prevent a dependent user from purchasing any products related to alcohol, such as beer, wine, and liquor, the primary user sets a limit of zero (0) dollars on the product types related to alcohol. In other embodiments of the invention no transaction amount limits are included on the blocked list, and as such if a product is added to the blocked list the dependent user simply is not allowed to purchase the product. This may also apply to an approved list in which the products on the approved list are the only products for which the dependent user may enter into transactions.

In some embodiments of the invention the primary user can put different limits on the same products, as was described with respect to the merchant limits in block 204. In other embodiments of the invention products limits may be added to a blocked/approved list in addition to merchant limits. For example, as illustrated in FIGS. 5 and 6, the primary user can set a limit of five hundred (500) dollars at the campus bookstore, which allows the dependent user to purchase the necessary books for classes, and also set a limit of four hundred (400) dollars on books (e.g., Category 2) and one hundred (100) dollars on other school products (Category 1) to control how the five hundred (500) dollars can be spent at the campus bookstore.

In order to add the products to the blocked/approved list, in one embodiment, the primary user may enter the products identifiers (e.g., SKU, UPC, product names, brand names, or the like) directly into the blocked/approved list. In other embodiments, the primary user may enter the products identifiers (e.g., SKU, UPC, product names, brand names, or the like) into a search feature and thereafter into the blocked/approved list after each is found through the search feature. As illustrated in the product search section 630 of FIG. 6, the primary user can enter the name of a product into the name section 632, the product code into the product code section 634, the brand into the brand section 636, or the category type into the category section 638, and thereafter select the search button 650 to identify the product, brand, product category based on the search criteria. When the correct product, brand, category, or the like is determined the primary user can select the add button 652 to add the product to the blocked/approved list. Thereafter, the primary user can set the monetary limits for the products, brands, or products categories and/or time limits as described with respect to block 208, and as further described below with respect to block 210 of FIG. 2A. In other embodiments of the invention, the blocked/approved lists or the product search section 630 includes drop-down features or browsing lists that contain the products, brands, categories, or other like product identifiers that allow a primary user to identify the products that the primary user wants to add to the blocked/approved lists.

In some embodiments of the invention the primary user can add a range of product codes to the blocked/approved list, such that the dependent user does not need to add every individual product code to the blocked/approved list, as described with respect to the merchant limits above.

As discussed briefly above and illustrated by block 210 in FIG. 2A, the primary user may also set time limits on the dependent account. In some embodiments of the invention, the primary user can set an overall account limit for a period of time, such as but not limited to time of day, period of day, day of the week, number of days, weeks, number of weeks, months, number of months, year, or the like. The primary user can also set time limits on the individual merchant limits or products limits, such as time of day, period of day, day of the week, number of days, weeks, number of weeks, months, number of months, years, or the like. Therefore, not only can the primary user set time limits for days, weeks, months, or the like but the time limits may include time of day limits (e.g., morning, afternoon, night), or specific hours of the day (e.g., between 11 am and 1 pm, or the like). As such, for example the primary user may limit specific transactions of the dependent user for only specific times in the morning. For example, the primary user may want to limit the dependent users purchases for breakfast to a particular restaurant (e.g., campus restaurant) and for a particular amount (e.g., the user can't buy breakfast for friends), to make sure the dependent user has funds available for eating breakfast before class. Moreover, a time of day limit may provide additional options to the primary user control the purchases of the dependent user. For example, the primary user may set a time of day limit of between 6 am and 8 am for breakfast purchases to make sure that if the dependent user wants to purchase breakfast the dependent user has to be up to make the purchase before Sam and before the dependent user's first class.

Moreover, the time limit may be set over a period of time as a percentage of the overall account limit for a specific period of time. For example, the account limit on books may be set by the primary user at five-hundred (500) dollars. Thereafter, the primary user can set a limit that the dependent user can spend one-hundred (100) percent of the account limit in September, fifty (50) percent of the account limit in October, and zero (0) percent the rest of the year. This allows the primary user to set a changing limit over a span of time to cover the approximate time periods in which the dependent user is likely going to enter into the transactions.

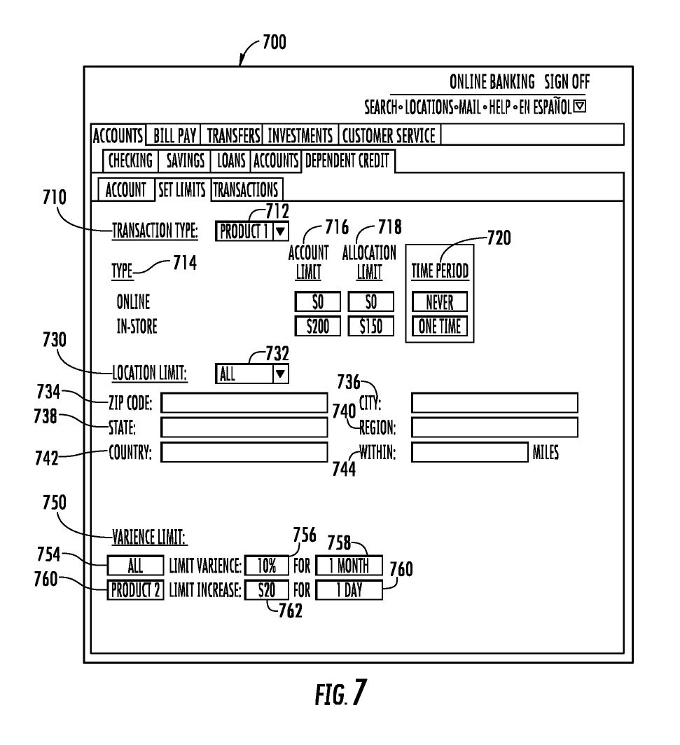

As illustrated by block 212 of FIG. 2A, the primary user may further set transaction type limits on the dependent account. As illustrated by block 214 of FIG. 2A, the primary user may also set location limits on the dependent account. Block 216 further illustrates that the primary user may set variance limits on the dependent account. On example of these types of limits are illustrated in the limit interface 700 illustrated in FIG. 7. As illustrated in FIG. 7, the limit interface 700 may include a transaction type limit section 710, a location limit section 730, and a variance limit section 750.

The transaction type limit section 710 may include a selection feature 712 that allows the primary user to set the transaction type limit on all purchases, all merchants, specific merchants, all products, specific products, or the like for the blocked/approved list in the dependent account. As illustrated in one example in FIG. 7, the primary user may select “Product 1” using the selection feature 712, and limit the transactions for “Product 1” to only in-store transactions. As illustrated in FIG. 7, the transaction type limit section 710 may include the transaction type limit 714, the transaction amount limit 716, the allocation limit 718, and/or a time limit 720. As such, for “Product 1” the primary user may limit the purchases to only in-store purchases, as illustrated. The primary user may want to limit some transactions using the dependent account to only purchases on-line, to only purchases in-store, or make specific monetary limits for on-line transactions or in-store transactions for various types of transactions. In still other embodiments of the invention, the primary user may limit purchases online to only specific online websites. For example, as previously described the use of the dependent account may be limited to a specific product from a specific merchant, but the transaction type limit may allow a dependent user to purchase the product made by the merchant from various websites. For example, a product from a merchant may be sold directly by the merchant over the merchant's website, or by other merchants over multiple different websites (e.g., new or used products over distributor websites or secondary market websites). As such, the present invention allows the primary user to set limits not only on the merchants and products, but also where the user may purchase these products over the internet. In other embodiments of the invention, other transaction type limits may be placed on the use of the dependent account, such as but not limited to preventing or allowing cash advances from the dependent account, use of the dependent account as a debit account or credit account, or the like.

The location limit section 730, like the transaction type limits section 710, may include a selection feature 732 to allow the primary user to indicate to what transactions the location limit may apply (e.g., all transactions, merchants, products, or the like). As illustrated in the selection feature 732 of FIG. 7 the location limit may apply to all transactions using the dependent account. As illustrated the location limit section 730 may include a zip code limit section 734, a city limit section 736, a state limit section 738, a region limit section 740, a country limit section 742, or a radius limit section 744. As such the primary user may select a transaction, such as “All” transactions and then utilize the location limits to control the use of the dependent account by the dependent user. As such, the primary user may set a location limit by indicating a zip code (or zip code range) in the zip code limit section 734 that limits the transactions using the dependent account to transactions within the zip code (or zip code range). The primary user may also set a location limit by indicating a city (or group of cities) in the city limit section 736 that limits the transactions using the dependent account to transactions within the selected city (or group of cities). The primary user may also limit the transactions to a state (or multiple states), or a region (or multiple regions), such as the southeast region of America, in a state limit section 738 or a region limit section 740 in order to limit the transactions using the dependent account to within a particular state or region (or groups of states or regions). The primary user may also set a location limit by indicating a county in the country limit section 742 to limit transactions using the dependent account in specific countries. The primary user may also set location limits based on a specific radius limit from a specific location using a radius limit section 744. For example, in one embodiment the primary user may select the dependent user's home address, the primary user's home address, the current location of the dependent user, the location of the dependent user at a point in time in the past or the future, or any other location, and furthermore, set a radius (e.g., miles, kilometers, feet, yards, meters, or the like) to limit the transactions using the dependent account to within the specified radius. In some embodiments of the invention, merchants or a group of merchants may have stores or an area of a store bounded using an electronic boundary in which the merchants may detect a customer or allow as customer to electronically or wirelessly enter into transactions within the area. As such, in some embodiments of the invention location limits may be placed on the use of a dependent account either preventing or limiting the purchases that a dependent user may be able make within an electronic boundary. Other location limits not specifically described herein may also be used to limit the transactions of a dependent user to a specific location.

As illustrated by block 216 the primary user may also set variance limits on the other limits set on the dependent account. As with the transaction type limit section 710 and the location limit section 730, the primary user may utilize a selection feature to indicate to what transactions the variance limit may apply (e.g., all transactions, merchants, products, or the like). As illustrated by the variance limit section 750 the primary user may set the variance limits as a percentage, an increased amount, or the like. For example, as illustrated in FIG. 7 the a transaction identifier 754 may be selected (e.g., all transactions), a variance limit 756 for the transaction may be set (e.g., such as 10%), and a variance time limit 758 may be set (e.g., one month, or the like) indicating that the transactions made using the dependent account may exceed the provided limits by 10% for the current month. In another example, the primary user may increase the limit for a specific product (or merchant) using a transaction identifier 760, set a variance limit 762 (e.g., $20), and set a variance time limit 764 in order to increase the limit for a specific product for a specific amount of time. In other embodiments of the invention the variance limits may be negative limits, such that the primary user may decrease the limit for a specific product (or merchant). For example, the primary user may want to punish or reduce the spending of the dependent user for a period of time, and thus may set a negative variance limit (e.g., −$20 or −10%) such that the transaction amount limit is reduced for a period of time. During the course of the use of the dependent account the dependent user may need to purchase items using the dependent account that are one time purchases that cost more than the limits already set on the dependent account. As such, instead of having to add a specific product, change the price limits, or the like (and thereafter change them back in the future after the purchase is made) the primary user may set variance limits on the total account limit, merchants, products, time limits, transaction types, location limits, or the like that are already included in the dependent account limits to allow the dependent user to enter into transactions over a specified amount of time that previously may not have been allowed.

In some embodiments of the invention the limit interface 700 can be populated by the primary user using drag and drop features in order to set the limits in the limit interface 700.

In some embodiments of the invention, instead of creating limits that either block/approve transactions made by dependent users, other limits can be applied to merchants or products that serve simply as notification limits instead of denial/acceptance limits. Therefore, in some embodiments, the primary user allows the dependent user to make various types of transactions at stores or for products, but sets notification limits in order to be notified when the dependent user enters into transactions. In these embodiments, the primary user can track the transactions made by the dependent user without having to limit the types of transactions made by the dependent user.

In still other embodiments of the invention other identifiers can be used in place of or in conjunction with the merchant identifiers or product identifiers. For example 2D barcodes, Quick Response codes (“QD codes”), RFID tags, or the like that are assigned to products could be added to a blocked/approved list of merchants or products in the dependent account. Therefore, products that the dependent user tries to purchase at a merchant, which use these product identifiers may be checked by the dependent account application 27 against the blocked/approved list before the transaction is approved.

As illustrated by block 218 in FIG. 2A, the financial institution (more specifically the systems and applications run by the financial institution or a third party entity) receives an indication that the dependent user has entered into a transaction. As illustrated by block 220 in FIG. 2A, the financial institution determines if the transaction meets or violates one or more limits set on the dependent account, which were set up by the primary user. For example, a customer may try to make a purchase at a physical store of a merchant or through an online store remotely over the Internet using the dependent account. The dependent account is swiped through a card scanner, is manually entered, automatically populated, wirelessly entered, or the like into a merchant system 7 either at the physical store location or remotely through an online store over the Internet. The merchant system 7 communicates with the dependent credit system 20 through the network 2, as explained in further detail later. The dependent account system 20 identifies if the dependent account being used by the customer belongs to the primary user or to one of the dependent users (e.g., if there is more than one dependent user) using the account identifiers (e.g., account numbers or other identifiers). The account identifier could be printed on the card and/or electronically captured in a magnetic strip, a radio frequency identification tag, or the like that is on or associated with the payment device (e.g., physical card, mobile wallet, or the like). If the customer making the purchase is the primary user and if the dependent account has not reached the maximum balance, then the transaction is allowed to proceed. If however the customer trying to make the purchase is the dependent user, then dependent account system 20 cross references the transaction information with the limits (e.g., merchant limit, product limit, transaction type limit, location limit, and/or other like limits) from the blocked/approved list of transactions in the dependent account for the particular dependent user.

In one example, when the merchant system 7 makes the request to connect to the dependent account system 20, or sometime thereafter, identifier information about the merchant and/or product involved in the transaction, such as but not limited to MCCs, store names, store addresses, store types, UPCs, product names, product types, or other like transaction information (e.g., price, transaction type, transaction location, or the like) are received by the dependent account system 20. The dependent account application 27 utilizes the transaction information to determine if the transaction has been blocked/approved by the primary user. If the merchant and/or products involved in the transaction are not on the blocked list (or are on the approved list), then the other limits on the dependent account are identified. The dependent account application 27 determines if the merchant and/or product are subject to any transaction amount limits, such as but not limited to an amount that the dependent user cannot exceed when making a purchase at the merchant and/or for the product. If the purchase being made by the dependent user is not within the transaction amount limit then the transaction is denied by the dependent account application 27. If however, the purchase is within the transaction amount limit then the dependent account application 27 determines if the purchase is within the transaction time limits set by the primary user. For example, the purchase could be within the transaction amount limits for a one-time purchase, but the purchase could push the dependent user over the limit for the number of purchases made within a month and/or the total amount of all the purchases made within the month. If the purchase being made by the dependent user is not within the transaction time limits then the transaction is denied. If however, the purchase being made by the dependent user is within the transaction time limits then the transaction is allowed to proceed. The other limits related to the transaction type limit, location limit, variance limit, or other like limits are also checked to determine if the transactions will be allowed or denied, or if a notification should be sent to the primary user regarding the transaction.

In some embodiments, as illustrated by block 222 in FIG. 2A an alert may be sent to the primary user regarding the transaction to inform the primary user, request authorization, or to increase a price limit, expand the merchant limit or the product limit, or the like in order to allow the transaction to proceed. As illustrated by block 224 in FIG. 2A the financial institution (e.g., dependent account system 20) will then allow or deny the transaction depending on whether or not the transaction meets or fails to meet to limits set on the dependent account.

At any time during the use of the dependent account (e.g., credit card) the primary user or dependent user can log into their online banking account to view the transactions made using the dependent account. In some embodiments, the dependent user has a separate online banking account, login name, and password from the primary user. This allows the dependent user to view any transactions using the dependent account, but prevents the dependent user from being able to make changes to the limits on the blocked/approved lists of merchants, products, or other like limits.

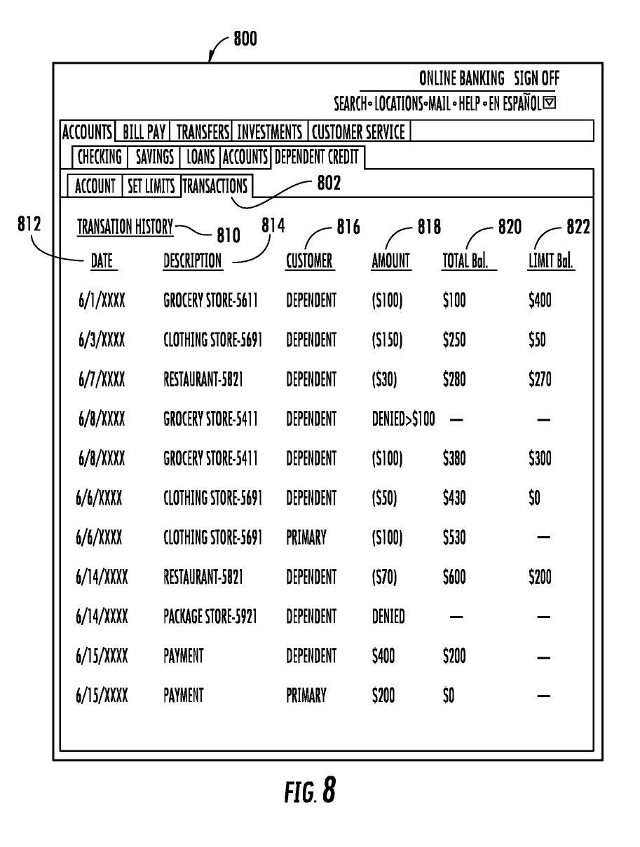

FIG. 8 illustrates a transaction history interface 800 located in a transactions tab 802 that allows the primary user to view the transactions made using the dependent account. In some embodiments of the invention the same or similar transaction history interface is also available for viewing by the dependent user in the dependent user's online banking account. As illustrated in FIG. 8, the transaction history interface 800, in some embodiments, has a transaction history section 810 that lists the transaction date 812, the transaction description 814, the transaction customer 816 that made the transaction, the transaction amount 818, the total account balance 820, and the transaction limit balance 822 for the transaction. When the dependent user tries to make a transaction that does not meet the limits set by the primary user the transaction is denied. For example, as illustrated in FIG. 8, the grocery store transaction made on June 8^{th} is denied because the amount was more than the limit of one-hundred (100) dollars in a single day for grocery stores.

In some embodiments, the primary user can also make purchases with the dependent credit card. In one embodiment, the primary user and dependent user both have different account numbers that are linked to the dependent account. In other embodiments, the primary user and dependent user have the same account number, but have identifiers that distinguish them from each other when making purchases. In other embodiments, the primary user does not have an account linked to the dependent account, and thus even though the primary user has control over the account the primary user cannot make purchases using the account. As illustrated in FIG. 8 in some embodiments the primary user is not subject to the limits that the primary user placed on the dependent user when the primary user is making a purchase with the dependent credit card. As illustrated by the transaction made on June 6^{th} in FIG. 8, the primary user is able to make a purchase at the clothing store after the dependent user has already reached the spending limit on clothing stores set by the primary user. In some embodiments the dependent account can be set to apply to the primary user as well as the dependent user (e.g., to ensure the account limits are not surpassed when the primary user is making purchases for the dependent user). As illustrated by the payment transactions made on June 15^{th} both the primary user and dependent user can make payments on the card. Having a credit card that can be paid in part by the dependent user can help the dependent user build transaction history when the dependent user might have otherwise not been approved for an account.

In the case where the dependent account is a dependent debit account (e.g., debit card), the settlement process would work differently than as described for a dependent credit card. Instead of carrying a balance on the dependent credit card as illustrated in FIG. 8, which is paid off though billing cycles by the users, in the case of the dependent debit card the transaction payment is deducted from an account associated with the dependent debit card when the transaction occurs, or shortly thereafter. Therefore, a dependent debit application may not only check the limits on a dependent debit card when a transaction is made using the dependent debit card, but may also check the available balance in the dependent debit account when the transaction is made.

In other embodiments of the invention, the primary user and/or the dependent user can request to be notified when a particular limit is close to being reached or has been reached. For example, in some embodiments the primary user or dependent user can request a notification from the dependent account when the dependent user has reached a percentage of a transaction amount limit, such as 80 percent of the funds that can be spent at grocery stores. This feature allows the primary user and/or the dependent user to be aware of the spending of the dependent user. As such, the primary user may change the limits if necessary, add variance limits for a period of time to the limits, and/or allow the dependent user to control his spending or request that the primary user change the limits. These features also allow the primary user and the dependent user to pay down certain limits or change the variance on the limits before they reach the maximum limit in order to prevent additional transactions from being denied. In some embodiments the primary user can set notification alerts in order to be notified when the dependent user makes a transaction at a store or for a product, type of store or product, range of stores or products, or the like, in order to make payments on the transactions before the end of the billing cycle. In some embodiments, the primary user may want to pay off some transactions immediately or sometime before the end of the billing cycle, therefore the notification alerts allow the primary user to payoff certain transactions made by the dependent user. Furthermore, in some embodiments the primary user can link the dependent account to another account and set up automatic payments to occur at various times for various transactions made by the dependent user.

The primary user can at any time log into the dependent account (e.g., through an online banking account) and edit the limits set on the dependent credit card. For example, if the primary user originally set a limit of five hundred (500) dollars at the campus bookstore so the dependent user could buy books for classes, the primary user can change the limit to zero (0) dollars after the dependent user has purchased the books, in order to prevent the dependent user from making purchases at the campus bookstore for other products, such as clothing or other supplies. When the primary user first sets up the limits on the dependent credit card and/or at any point thereafter when the primary user changes the limits on the dependent credit card a notification can be sent to the dependent user identifying the limits that were set or changed by the primary user. In some embodiments the dependent user can be notified of any limits set or changed by the primary user through text message, e-mail, telephone call, or any other like communication channel.

In the embodiments where there is more than one dependent user under the account of the primary user, each dependent user may have their own limit interfaces 500, 600, 700 and transaction history interfaces 800. The separate interfaces for each dependent user allows the primary user to better manage each account because the primary user can set limits and view the transaction history of each dependent user individually based on the needs of each of the individual dependent users.

Regardless of whether or not the transactions using the dependent account were approved or denied, in some embodiments the transactions are posted and saved to the transaction history interface 800, in order to allow the dependent user, and more importantly, the primary user to see the purchases that the dependent user tried to make using the dependent account.

In some embodiments of the invention, a primary user can utilize a mobile device, which includes a data capture system, to set limits on stores directly at the store location. In one embodiment, the primary user can utilize the mobile device, having a data capture system comprising a data capture device and a data capture application, such as but not limited to a GPS device and application, a scanning device and application, an image capture device and application, and/or a wireless transmitter device and application. For example, in one embodiment, if the primary user is in a location, such as a store, restaurant, or the like, which the primary user would like to add to the list of blocked/approved merchants, the primary user can use the mobile device to add the store to the blocked/approved list. In some embodiments, the primary user can log into his dependent account through the online banking application 17 using a mobile device, such as but not limited to a smartphone. The mobile device may have a GPS device and an application that can determine the location of the primary user. Therefore, while the primary user is logged into the dependent account the primary user can select a function in the dependent account that adds the primary user's current location to a blocked/approved list. The dependent account application 27 may add the store automatically or it may display the location to the customer on the mobile device for the primary user's approval. The dependent account application 27 can save the store identified by the GPS application to the list of blocked/approved stores. In other embodiments, instead of using GPS to identify the store location, the primary user can take an image of the store, store name, address, or other identifier, and an image capture application can use the image or data captured in the image to identify the store by cross-referencing the image or data of the store with information stored by the bank or other entities over the network 2. When the image capture application identifies the store the dependent account application 27 can add the store to the blocked/approved list automatically or it may display the store on the mobile device for the primary user's approval. In still other embodiments of the invention the primary user can use a wireless transmitter device and wireless transmitter application in the mobile device to capture information about a store indentifying the store by type, name, address, or the like in order to add the store to the a list of blocked/approved stores in the dependent account. The wireless transmitter device can receive information about a store from a transmitter, such as but not limited to a RFID tag, located at the store. When the wireless transmitter application identifies the store the dependent credit application 27 can add the store to the blocked/approved list automatically or it may display the store on the mobile device for the primary user's approval to add the store to the blocked/approved list of stores. In still other embodiments of the invention the primary user can scan a barcode, or other identifier, using a scanning device and a scanning application in the mobile phone, to identify the store location. The dependent account application 27 can utilize the scanned information to add the store to the list of blocked/approved stores.

In some embodiments of the invention, a primary user can utilize a mobile device, which includes a data capture device, to set limits on products located directly at the store or at any other location, as previously described with respect to adding merchant limits. For example, in one embodiment, the primary user can identify a product that the primary user would like to add to the blocked/approved list. The primary user can log into his dependent account through an online banking application 17 using a mobile device, such as but not limited to a smartphone. As such, while the primary user is logged into his dependent account the primary user can select a function in the dependent account that adds a product to the blocked/approved list of products using a scanning device. Thereafter, the primary user can use a scanning device and scanning application in the mobile device to capture information on the product, associated packaging, or associated marketing materials identifying the product by name, SKU, UPC, or other identifier in order to add the product to a list of blocked/approved products in the dependent account. For example, in one embodiment the scanning device can be a laser scanner that captures the barcode UPC of the product and adds the product to the blocked/approved list of products. The dependent account application 27 may add the product automatically or it may display the scanned product to the primary user on the mobile device for the primary user's approval to add it to the blocked/approved list. In other embodiments of the invention, while the primary user is logged into his dependent account the primary user can select a function in the dependent account that adds a product to the blocked/approved list of products using an image capture device. Thereafter, the primary user can use an image capture device and image capture application in the mobile device to capture information on the product, associated packaging, or associated marketing materials identifying the product by name, SKU, UPC, or other identifier in order to add the product to the a list of blocked/approved products in the dependent account. The image capture application can use an image or data obtained from the image, through character recognition software or other software, for cross-referencing with images or data of products stored by the bank or other entities over the network 2. When the image capture application identifies the product related to the image captured by the primary user the dependent account application 27 can add the product to the blocked/approved list automatically or it may display the product on the mobile device for the primary user's approval to add the product to the blocked/approved list of products. In still other embodiments of the invention the primary user can use a wireless transmitter device and wireless transmitter application in the mobile device to capture information on a product, associated packaging, or associated marketing materials indentifying the product by name, SKU, UPC, or other product identifier in order to add the product to the a list of blocked/approved products in the dependent account. The wireless transmitter device can receive information about a product from a transmitter, such as but not limited to a RFID tag on or near the product. When the wireless transmitter application identifies the product the dependent credit application 27 can add the product to the blocked/approved list automatically or it may display the product on the mobile device for the primary user's approval to add the product to the blocked/approved list of products.

Furthermore, in other embodiments of the invention the primary user can also set other limits on the merchants or products added to the blocked/approved list using the mobile device, such as but not limited to transaction account limits, transaction time limits, or the like, as previously explained herein.

In other embodiments of the invention the dependent user can utilize a mobile device, which includes a data capture device and a data capture application, to check to see if limits have been applied by the primary user on a merchant at which the dependent user is located or on a product in which the dependent user is interested. This embodiment can work in the same or similar way as described with respect to the primary user setting limits on merchants and products using a mobile device herein. For example, the dependent user can utilize a mobile device, having a data capture system comprising a data capture device and data capture application, such as but not limited to a GPS device and application, a scanning device and application, an image capture device and application, and/or a wireless transmitter device and application. The dependent user can use the data capture device and application to capture information about a store, such as the store MCC, store type, name, address, or other like merchant identifier, and/or information about a product, such as but not limited to UPC, product name, product type, other product identifier, or the like, and use the information to determine if the primary user placed any limits on the dependent account for the merchant or product, or any other type of limit. In some embodiments, the dependent user can log into his dependent account through the online banking application 17 using a mobile device, such as but not limited to a smartphone. The data capture device and application captures the information about the merchant and product, as previously discussed, and the dependent account application 27 determines if the store or product is on the blocked/approved list of merchants and products. Thereafter, the dependent account application 27 can display to the dependent user any limits on the merchant or product through the dependent account on the mobile device. In this way the dependent user can check if a transaction would be allowed at the store or on the product before making an effort to purchase a product.

In other embodiments of the invention, instead of having to be logged into the dependent account in order for the dependent account application 27 to display to the user 9 on the mobile device if the merchant or product is on the blocked/approved list, the system can work in other ways. For example, after the data capture device captures information about the merchant or product on the mobile device, the mobile device can send the information to the dependent account application 27, and the dependent account application 27 thereafter can send any information regarding limits on the merchant or product to the user 9 on the mobile device using text messages, e-mail, phone calls, or the like.

In some embodiments, when a transaction is being made at the checkout of a store, at a physical store location, or on the user computer system 20, the dependent account application 27 can display the limits, such as the transaction amount limit, the transaction time limit, or the like, as the limits would be if the customer were to make the transaction or not make the transaction. In this way, the dependent user can determine if a transaction that the he wants to make would be approved or if the transaction may prevent other transactions from being made in the future because the dependent user could potentially violate other limits set by the primary user.

In other embodiments, if the proposed transaction being made or inquired by the customer is denied, the dependent user can have the option of notifying the primary user asking to lift the limit on the transaction. The notification can come through text message, e-mail, phone call, through the dependent account, or the like. Thereafter, the primary user can change the limit permanently, override the limit as a one time exception, or keep the limit the same. An override function allows the primary user to allow the dependent user to enter into certain transactions (e.g., in times of need, emergency situations, or the like) that ordinarily would not be allowed. This feature can be implemented through many different types of payment scenarios. For example, in some embodiments the feature could be used if the dependent user is making a purchase at store checkout, in which the purchase would be denied because it violated a limit. The dependent account application 27 could notify the primary user before the transaction is denied, to allow the primary user to override the limit as a one time exception. In other embodiments, the dependent user could notify the primary user through the online banking application that he wants to make a purchase that he knows will be denied in order to get approval for the transaction before the dependent user tries to make the purchase. For example, the dependent user could notify the primary user of a purchase on a product through the mobile device and the primary user could respond by allowing the transaction. Thereafter, the dependent account application 27 would allow the one time transaction that does not meet the limits set in the dependent account based on the override provided by the primary user.

In some embodiments of the invention, a reward system can be implemented for the dependent account. In addition to limits set by the primary user, the primary user may want to set spending goals that are lower than the limits in order to control the customer's spending, but leave enough credit available for the dependent user in case there is an emergency situation. For example, the primary user may set a limit of five-hundred (500) dollars at the bookstore in case the dependent user needs supplies from the bookstore; however, the primary user only wants the dependent user to spend three-hundred (300) dollars. In some embodiments the primary user can set of goal of three-hundred (300) dollars and a limit of five-hundred (500) dollars on the bookstore. If the dependent user spends less than the goal for the specified time limit then the limit on another store or product can be removed, or increased. For example, the dependent user can now spend one-hundred (100) dollars at an electronics store. Alternatively, if the dependent user spends more than the goal then the limit on another store or product can be set or decreased. For example, the dependent user can no longer make purchases at movie theaters.

In the embodiments described throughout this specification, the online banking application 17 allows a user 9, either the primary user or the dependent user, to access and review the dependent account. In the case of a primary user, the user 9 can access the account, review the transaction history, edit the account limit, edit the merchants or products on the blocked/approved list, or edit other limits. In the case of a dependent user, the user 9 can access the account, review the transaction history, view the account limit, view the transaction account limits on merchants, products, or other limits through the privacy and security offered by the online banking application 17.

FIG. 2B illustrates another process of the present invention related to a dependent account allocation process 250 for determining the amount of a transaction using a dependent account that may be allocated to the dependent account, and the amount which will come from another payment method. As illustrated by block 252 in FIG. 2B the primary user applies for a dependent account for the dependent user, or links a current account to a dependent user to create a dependent account, as was previously discussed with respect to block 202 in FIG. 2A. Block 254 in FIG. 2B illustrates that a primary user sets transaction account limits on the dependent account as previously illustrated and discussed with respect to blocks 204, 206, and 210-216 in FIG. 2A.

As illustrated by block 256 in FIG. 2B, and as previously discussed with respect to block 208 in FIG. 2A the primary user sets transaction amount limits on the transactions using the dependent accounts. For example, a primary user sets a transaction amount limit for the value of one or more of the account limits illustrated in the merchant limit interface 500 or the product limit interface 600 in FIGS. 5 and 6 respectively. As illustrated, the transaction amount limit may be the maximum amount that the primary user can spend to enter into a transaction with a merchant, a type of merchant, for a product, a type of product, a product brand, or the like. For example, the primary user may limit the purchases made by dependent user, such as $300 at “Store 1” (e.g., electronics store) as illustrated in the merchant interface 500 of FIG. 5. Alternatively, or in addition, the primary user may limit the purchase of a product, such as “Product 1” (e.g., a TV) to $200 regardless of the merchant (e.g., electronics store, big box stores, all-in-one stores, or the like).

As illustrated by block 258, the primary user may also set an allocation limit for the transaction amount limit in block 256. The allocation limit may limit the amount of a transaction that can be applied to a particular dependent account. For example, continuing with the example provided for block 256, while there may be a $300 transaction amount limit for “Store 1”, the primary user may only want to apply a portion of the $300 transaction amount limit using a first dependent account. As such, the allocation limit may only be $200 for transactions with Store 1. As such, while the primary user allows the dependent user to make a purchases up to $300 at “Store 1” (e.g., electronics store), the primary user only wants to allow the dependent user to apply $200 from the transaction to the dependent account. In this way, the primary user can allow the dependent user to enter into transactions and pay a portion of the transactions, but may also limit the total amount of the transactions applied to the dependent account. In continuing with the example, the primary user may also set a limit for a specific product or products that may be purchased by the dependent user regardless of the store. For example, “Product 1” (e.g., TV) may have a transaction amount limit of $200; however, the allocation limit may only allow $150 of the purchase of “Product 1” to be allocated to the dependent account.

As illustrated by block 260 in FIG. 2B, within the dependent account the primary user or the dependent user may set alternate accounts that can be used for the difference between the transaction amount limit and the allocation limit. For example, the primary user may indicate that another account of the primary user may be utilized for the difference. More particularly, the dependent user may indicate that another account may be utilized to make up the difference between transaction amount and the allocation amount. For example, the dependent user may indicate that any differences between the transaction price and an allocation limit should be made up through the dependent user's checking account, savings account, investment account, credit card account, or the like, of which these accounts may or may not be dependent accounts with the primary user or another user. In other embodiments, the difference may be made up by cash payments at the point of sale.

As illustrated by block 262 of FIG. 2B, the financial institution (e.g., the dependent account system 20) may receive an indication that the dependent user has entered into a transaction. As previously discussed, the dependent user may enter into a transaction online or at a store location, and the merchant or other entity handling the transaction can send the transaction details to the financial institution or other entity associated with the account. As illustrated by block 264, the financial institution or other entity associated with the account determines if the transaction meets or violates the transaction account limits (e.g., merchant, product, transaction type, location limits, or the like) on the dependent account. As illustrated by block 266 when the transaction account limits are violated (e.g., not met) the transaction is denied. However, as illustrated by block 268 when the transaction account limits are met the financial institution determines if the transaction meets the transaction amount limits for the transaction. As illustrated by block 270, when the transaction amount limits are violated the transaction is denied. However, when the transaction amount limits are met the transaction is allowed, as illustrated in block 272.

As illustrated by block 274 when the transaction is allowed a determination is made if the allocation limit is met or violated. As such, the transaction amount is compared to the allocation limit, and if it is below or equals the allocation limit the transaction amount is applied to the dependent account, as illustrated by block 276. However, when the allocation limit is not met a payment deficiency is determined related to the difference between the transaction amount and the allocation limit, as illustrated by block 278 of FIG. 2B. As such, a determination is made as to what alternate accounts are going to be used to cover the deficiency. In other embodiments of the invention a deficiency amount is not specifically determined when the allocation limits are not met (e.g., violated), and the system simply determines the alternate account from which to debit the remainder of the transaction amount. Block 282 of FIG. 2B, illustrates that the transaction is completed by assessing payment from (e.g., debiting, charging, or the like) the dependent account as well as the alternate account.

When the allocation limit is violated the transaction may be handled at the point of sale, or otherwise may be handled on the back end by the financial institution. For example, at the merchant (e.g., at a physical store, or online through a website or application) when the transaction is allowed, but the allocation limit is not met only a portion of the transaction up to the allocation limit is charged to the dependent account and the remainder of the transaction amount is requested by the merchant at the time of the sale. As such, the dependent user entering the transaction may be required to complete the payment by providing another form of payment other than the dependent account. For example, the dependent user may pay the remaining transaction amount by paying cash, using a gift card, using another account (e.g., credit card, debit card, or the like) or using another dependent account or another account of another user associated with the dependent user. As such, in this embodiment the payment is completed by the merchant up front and the two or more accounts or payments are assessed by the merchant.

In other embodiments of the invention when the transaction amount is met but the allocation limit is not met the transaction may be allowed by the financial institution. The financial institution may pay the full amount of the transaction, and debit the one or more dependent accounts and/or alternate accounts at the time of the purchase or at a later point in time. For example, at the time of the transaction the financial institution may pay the full amount of the transaction using the dependent account, and thereafter charge the transaction amount over the allocation limit to another account that the dependent customer has preauthorized (e.g., an alternate account for payments may be stored for the dependent account), or the financial institution may prompt the dependent user for an alternate account from which to assess the amount of the transaction over the allocation limit.

In one example, the dependent user may purchase “Product 1” and other products from “Store 1.” Based on the dependent account limits the dependent user can purchase up to $300 at “Store 1,” including “Product 1” up to $200, however only $150 of “Product 1” is allocated to the dependent account. As such, in one embodiment when “Product 1” is purchased from “Store 1” the transaction is allowed and the dependent account is debited $150 up to the allocation limit and “Store 1” requires that the dependent user provide an additional payment for the remaining $50. In other embodiments when “Product 1” is purchased from “Store 1” the transaction is allowed by the financial institution and the dependent account is debited $150 up to the allocation limit, while another alternate account that has been preauthorized by the dependent user or the primary user is debited for the remaining $50. In still other embodiments, when “Product 1” is purchased from “Store 1” the transaction is allowed by the financial institution and the dependent account is debited $200 up to the transaction amount, and the financial institution either prompts the user with a notification asking the dependent user from which account the $50 over the allocation limit should be debited. Transactions may occur at the merchant side or at the financial institution side in a number of different ways that have been generally discussed herein, or otherwise not specifically discussed herein, but which should be understood by one of ordinary skill in the art.

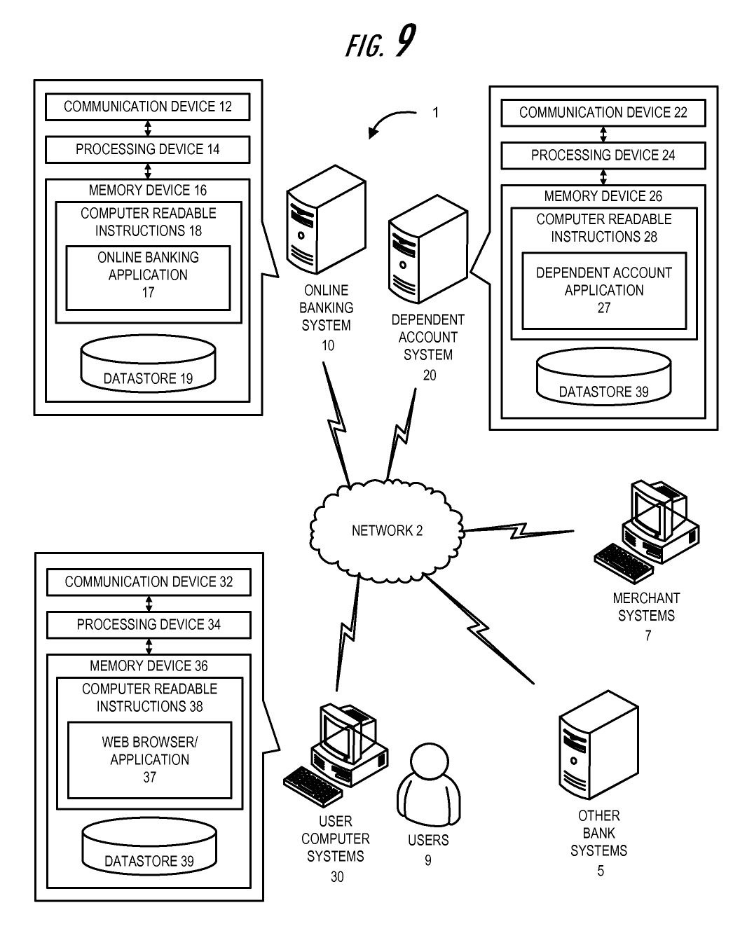

FIG. 9 illustrates a dependent account environment and system 1, in accordance with an embodiment of the present invention. As illustrated in FIG. 9, the online banking system 10 is operatively coupled, via a network 2 to the dependent account system 20, other bank systems 5, merchant systems 7, and user computer systems 30. In this way, the online banking system 10 can receive and send information from and to the dependent account system 20, user systems 30, merchant systems 7, and other bank systems 5, such that users 9 can view, sign up for, or manage their dependent accounts through online banking accounts. FIG. 9 illustrates only one example of embodiments of a dependent account environment and system 1, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 9, the online banking system 10 generally comprises a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the dependent account system 20, other bank systems 5, merchant systems 7, and user computer systems 30. As such, the communication device 12 generally comprises a modem, server, or other device for communicating with other devices on the network 2.

As further illustrated in FIG. 9, the online banking system 10 comprises computer-readable instructions 18 stored in the memory device 16, which in one embodiment includes the computer-readable instructions 18 of an online banking application 17. In some embodiments, the memory device 16 includes a datastore 19 for storing data related to the online banking system 10, including but not limited to data created and/or used by the online banking application 17. As discussed above the online banking application 17 allows the users 9 to access the dependent account, set limits, edit limits, view limits, or the like.

As further illustrated in FIG. 9, the dependent account system 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the online banking system 10, other bank servers 5, merchant systems 7, and/or user computer systems 8. As such, the communication device 22 generally comprises a modem, server, or other device(s) for communicating with other devices on the network 2.

As illustrated in FIG. 9, the dependent credit systems 20 comprise computer-readable program instructions 28 stored in the memory device 26, which in one embodiment includes the computer-readable instructions 28 of a dependent account application 27. In some embodiments, the memory device 26 includes a datastore 29 for storing data related to the dependent account system 20, including but not limited to data created and/or used by the dependent account application 27, such as dependent user limits. The dependent account application 27 allows the primary users to establish, edit, and view dependent accounts through the online banking application 17. The dependent account application 27 stores the limits for the dependent accounts that are established by the primary users.

As further illustrated in FIG. 9, the user computer systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the online banking system 10, dependent account system 20, merchant systems 7, and/or other bank systems 5. As such, the communication device 32 generally comprises a modem, server, or other devices for communicating with other devices on the network 2, and a display, camera, keypad, mouse, keyboard, microphone, and/or speakers for communicating with one or more users 9. The user computer systems 30 may include, for example, a personal computer, a laptop, a tablet, a mobile device (e.g., phone, smartphone, or personal display device (“PDA”), or the like) or other devices, or the like. In some embodiments, the user computer systems 30, such as a mobile device or other devices, could include a data capture device that is operatively coupled to the communication device 32, processing device 34, and the memory device 36. The data capture device could include devices such as, but not limited to, a scanner device, image capture device, wireless data capture device, location determine device, or other like device (e.g., radio frequency identification (“RFID”) device, global positioning satellite (“GPS”) device, or the like), which can be used by a user 9, institution, or the like to capture information from a user, a product or store, set limits, and/or allow or prevent transactions, as previously explained.

As illustrated in FIG. 9, the user computer systems 30 comprise computer-readable program instructions 38 stored in the memory device 36, which in one embodiment includes the computer-readable instructions 38 of a web browser/application 37. In some embodiments, the memory device 36 includes a datastore 39 for storing data related to the user system 30, including but not limited to data created and/or used by a web browser/application 37. The web browser/application 37 allows the user 9 to communicate with the online banking application 17 in order to accesses the user's dependent account through the dependent account application 27. In some embodiments a web browser is used to access websites, applications, or the like; however, in other embodiments a specific application (e.g., mobile application, computer application, or the like) is specifically configured to communicate with the online banking application 17, or other application described herein. In some embodiments of the invention, wherein the user computer systems 30 include a data capture device 36, the memory device 36 may include computer readable instructions 38 of a data capture application, which either alone, through the web browser/application 37, or through another application or system, communicates with the dependent account application 27, online banking application 17, or other applications. The data capture application allows a primary user to capture information about a product or merchant, and set limits on the product or merchant, which can be transferred to the dependent account application 27, or other applications or systems described herein. The data capture application also allows a dependent user to capture information about a product or merchant and check with the dependent account application 27 if he is allowed to make a transaction at the store or for the product.

The other bank systems 5 are operatively coupled to the online banking system 10, dependent account system 20, merchant systems 7, and user computer systems 30 through the network 2. The other bank systems 5 have devices the same or similar to the devices described for the online banking system 10, dependent account system 20, and user computer systems 30 (i.e. communication device, processing device, memory device with computer-readable instructions, datastore, or the like). Thus, the other bank systems 5 communicate with the online banking system 10, dependent credit system 20, merchant systems 7, and/or user computer systems 30 in the same or similar way as previously described with respect to each system. The other bank systems 5, in some embodiments, are comprised of systems and devices that store and access account information or other information within or outside of the bank.

The merchant systems 7 are operatively coupled to the online banking systems 10, dependent account systems 20, user computer systems 30, and other bank systems 5 through the network 2. The merchant systems 7 have devices the same or similar to the devices described for the online banking system 10, dependent credit system 20, and user computer systems 30 (i.e. communication device, processing device, memory device with computer-readable instructions, datastore, or the like). Thus, the merchant systems 7 communicate with the online banking system 10, dependent credit system 20, user computer systems 30, and/or other bank systems 5 in the same or similar way as previously described with respect to each system. The merchant systems 7 can be computer systems that incorporate scanners, manual input devices, or other data reading devices that can read and capture information embedded in credit cards or other payment devices through magnetic strips, radio frequency identification tags, other wireless transmitters, other scanable features, manually inputted information, or the like. In other embodiments of invention the merchant systems 7 include applications that allow purchases to occur over the network 2.

The information captured by the merchant systems 7 from the accounts and payment devices allows the merchant systems 7 to charge the accounts of the user 9. For example, the merchant systems 7 can be registers located in a store, Internet websites that are accessed by the user computer systems 30 remotely, or the like, which allow the users 9 to make purchases from the merchant using the dependent account, and/or other alternate accounts. Information related to the dependent account is captured at the store, on the website, or through an application, and transferred to the dependent account system 20.

It is understood that the systems and devices described herein illustrate one embodiment of the invention. It is further understood that one or more of the systems, devices, or the like can be combined in other embodiments and still function in the same or similar way as the embodiments described herein.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

U.S. patent application Ser. No. ______ to Schwalb, entitled “Purchase Limits with Primary Account Holder Control,” and filed concurrently herewith, is hereby incorporated by reference in its entirety.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A dependent transaction system, comprising:
a memory device; and
a processing device operatively coupled to the memory device, wherein the processing device is configured to execute computer-readable program code to:
receive a request from a primary user to set limits on a dependent account in order to control transactions a dependent user is permitted to make using the dependent account, wherein the limits comprise:
a transaction account limit, wherein the transaction account limit limits the transactions that the dependent user is permitted to make with merchants or for products;
a transaction amount limit, wherein the transaction amount limit allows for a dependent user to use a dependent account for the transaction based on an amount of the transaction;
an allocation limit, wherein the allocation limit sets the amount of the transaction that is assessed from the dependent account;
save the limits on the dependent account;
receive a request from a merchant for a proposed transaction using the dependent account;
receive transaction information related to the proposed transaction;
compare the transaction information for the proposed transaction against the limits;
deny the proposed transaction when the limits are violated; and
allow the proposed transaction when the limits are met, wherein when the proposed transaction is allowed a transaction amount is allocated against the dependent account up to or equal to the allocation limit.

2. The dependent transaction system of claim 1, wherein when the transaction amount is greater than the allocation limit the transaction amount over the allocation limit is allocated to an alternate account of the dependent user.

3. The dependent transaction system of claim 1, wherein the transaction account limit at least comprises a merchant limit, wherein the merchant limit is a blocked or approved merchant.

4. The dependent transaction system of claim 1, wherein the transaction account limit at least comprises a product limit, wherein the product limit is a blocked or approved product.

5. The dependent transaction system of claim 1, wherein the limits further comprise a transaction time limit, wherein the transaction time limit is a time period.

6. The dependent transaction system of claim 1, wherein the transaction account limit at least comprises a transaction type limit, wherein the transaction type limit is an online transaction limit or an in-store transaction limit.

7. The dependent transaction system of claim 1, wherein the transaction account limit at least comprises a location limit, wherein the location limit is based on the location of the dependent user at a time of the transaction based on a location determining device in a mobile device of the dependent user.

8. The dependent transaction system of claim 1, wherein the limits further comprise a variance limit on one or more of the transaction amount limits.

9. A computer program product for a dependent financial transaction system, the computer program product comprising at least one non-transitory computer-readable medium having computer-readable program code portions embodied therein, the computer-readable program code portions comprising:
an executable portion configured to receive a request from a primary user to set limits on a dependent account in order to control transactions a dependent user is permitted to make using the dependent account, wherein the limits comprise:
a transaction account limit, wherein the transaction account limit limits the transactions that the dependent user is permitted to make with merchants or for products;
a transaction amount limit, wherein the transaction amount limit allows for a dependent user to use a dependent account for the transaction based on an amount of the transaction;
an allocation limit, wherein the allocation limit sets the amount of the transaction that is assessed from the dependent account;
an executable portion configured to save the limits on the dependent account;
an executable portion configured to receive a request from a merchant for a proposed transaction using the dependent account;
an executable portion configured to receive transaction information related to the proposed transaction;
an executable portion configured to compare the transaction information for the proposed transaction against the limits;
an executable portion configured to deny the proposed transaction when the limits are violated; and
an executable portion configured to allow the proposed transaction when the limits are met, wherein when the proposed transaction is allowed a transaction amount is allocated against the dependent account up to or equal to the allocation limit.

10. The computer program product of claim 9, wherein when the transaction amount is greater than the allocation limit the transaction amount over the allocation limit is allocated to an alternate account of the dependent user.

11. The computer program product of claim 9, wherein the transaction account limit at least comprises a merchant limit, wherein the merchant limit is a blocked or approved merchant.

12. The computer program product of claim 9, wherein the transaction account limit at least comprises a product limit, wherein the product limit is a blocked or approved product.

13. The computer program product of claim 9, wherein the limits further comprise a transaction time limit, wherein the transaction time limit is a time period.

14. The computer program product of claim 9, wherein the transaction account limit at least comprises a transaction type limit, wherein the transaction type limit is an online transaction limit or an in-store transaction limit.

15. The computer program product of claim 9, wherein the transaction account limit at least comprises a location limit, wherein the location limit is based on the location of the dependent user at a time of the transaction based on a location determining device in a mobile device of the dependent user.

16. The computer program product of claim 9, wherein the limits further comprise a variance limit on one or more of the transaction amount limits.

17. A dependent transaction method, comprising:
receiving, by a processing device, a request from a primary user to set limits on a dependent account in order to control transactions a dependent user is permitted to make using the dependent account, wherein the limits comprise:
a transaction account limit, wherein the transaction account limit limits the transactions that the dependent user is permitted to make with merchants or for products;
a transaction amount limit, wherein the transaction amount limit allows for a dependent user to use a dependent account for the transaction based on an amount of the transaction;
an allocation limit, wherein the allocation limit sets the amount of the transaction that is assessed from the dependent account;
saving, by the processing device, the limits on the dependent account;
receiving, by the processing device, a request from a merchant for a proposed transaction using the dependent account;
receive, by the processing device, transaction information related to the proposed transaction;
comparing, by the processing device, the transaction information for the proposed transaction against the limits;
denying, by the processing device, the proposed transaction when the limits are violated; and
allowing, by the processing device, the proposed transaction when the limits are met, wherein when the proposed transaction is allowed a transaction amount is allocated against the dependent account up to or equal to the allocation limit.

17. The dependent transaction method of claim 16, wherein when the transaction amount is greater than the allocation limit the transaction amount over the allocation limit is allocated to an alternate account of the dependent user.

18. The dependent transaction method of claim 16, wherein the transaction account limit at least comprises a merchant limit, wherein the merchant limit is a blocked or approved merchant.

19. The dependent transaction method of claim 16, wherein the transaction account limit at least comprises a product limit, wherein the product limit is a blocked or approved product.

20. The dependent transaction method of claim 16, wherein the limits further comprise:
a transaction time limit, wherein the transaction time limit is a time period;
a transaction type limit, wherein the transaction type limit is an online transaction limit or an in-store transaction limit;
a location limit, wherein the location limit is based on the location of the dependent user at a time of the transaction based on a location determining device in a mobile device of the dependent user; and
a variance limit on one or more of the transaction amount limits.
